(19) United States
(12) Patent Application Publication
(10) Pub. No.: US 2003/0117525 A1
(43) Pub. Date: Jun. 26, 2003

(54) Method for outputting video images in video monitoring system

(76) Inventor: Hak-Sung Kim, Kwonsun-Gu (KR)

Correspondence Address: CANTOR COLBURN, LLP, 55 GRIFFIN ROAD SOUTH, BLOOMFIELD, CT, 06002

(21) Appl. No.: 10/257,654

(22) PCT Filed: Jun. 18, 2002
(86) PCT No.: PCT/KR02/01142

(30) Foreign Application Priority Data
Jun. 18, 2001 (KR) 2001/34404
Apr. 24, 2002 (KR) 2002/22567

(51) Int. Cl. H04N 11/20

(52) U.S. Cl. 348/445; 348/448

(57) ABSTRACT

A method capable of displaying high quality video images although a video capture device and a video display device are of different scanning types is disclosed. For example, a method for outputting video data in a video monitoring system outputting channel video signals of an interlaced scanning type captured by one or more cameras to a video display device of a progressive scanning type, comprises the steps of: scaling each channel video data of the interlaced scanning type digitally converted with different horizontal and vertical scaling ratios; storing the scaled video data for configuring one display screen in a memory; and outputting and displaying the stored video data corresponding to the one display screen to the video display device of the progressive scanning type.

### TECHNICAL FIELD

The present invention relates to a video monitoring system, and more particularly to a method capable of displaying high quality video images although a video capture device and a video display device are of different scanning types.

### BACKGROUND ART

A conventional video monitoring system captures a plurality of video signals, processes video data corresponding to the signals and displays the processed video data on a plurality of divided display screens divided within a monitor or display screen. A video camera generally captures the video signals of an interlaced scanning type. The video signals of the interlaced scanning type captured are outputted to a video display device such as a television through horizontal and vertical scalers, which have the same scaling ratio as each other.

Recently, a DVR (Digital Video Recorder) based on a PC (Personal Computer) is widely used to store increased quantities of video data. Because the monitor being the video display device equipped with the video monitoring system is of a progressive scanning type, quality of an image or resolution may be deteriorated. This will be described in detail with reference to FIG. 1.

First, as shown in FIG. 1(b), video signals of the interlaced scanning type captured by four video cameras are reduced by the horizontal and vertical scalers having the same scaling ratio as each other and displayed on four divided display screens. If the video signals of the interlaced scanning type captured shown in FIG. 1(c) are displayed on the display device of the progressive scanning type shown in FIG. 1(d), then elliptical video images are displayed as shown in FIG. 1(e). Where the elliptical video images vertically reduced to half are displayed on the display screen, there is a problem in that video images are distorted.

To address such a problem, four video data, which are composed of mixed odd and even fields shown in FIG. 1(f), respectively, are progressively scanned as shown in FIG. 1(g). At this time, an aspect ratio for each input data is the same as that for each output data. Accordingly, the video images can be properly displayed on the display screen. However, if the video images are moving images rather than still images, the deterioration of the resolution as well as the deterioration of the quality of the video images can occur, because there is a scanning time difference of 1/60 second between the odd and even fields and therefore blurred moving images are displayed.

Korean Patent Application No. 10-1998-52991 entitled “APPRATUS FOR DISPLAYING DIVIDED DISPLAY SCREENS USING SCAN LINE CONVERSION” is patented and laid open. An apparatus disclosed in Korean Patent Application No. 10-1998-52991 comprises two video decoders, two memories and two video encoders for scan line conversion. An output terminal of each encoder is connected to a television monitor and a computer monitor. Korean Patent Application No. 10-1998-52991 is characterized in that the apparatus records video data in a memory placed in a front stage of the video encoder connected to the computer encoder and reads the recorded video data at a reading speed twice as fast as a recording speed to perform the scan line conversion.

In Korean Patent Application No. 10-1998-52991, captured video signals are sequentially processed in a first video decoder, a first video encoder, a second video decoder and a second video encoder so that the video signals of the interlaced scanning type inputted from a video camera can be outputted to the computer monitor of the progressive scanning type. However, there is a problem in that the quality of an image is inevitably deteriorated. Further, because the recorded video data should be read at the reading speed twice as fast as the recording speed, there is another problem in that a clock is required to control the memory and therefore a design of a memory controller is complicated.

### DISCLOSURE OF THE INVENTION

Therefore, the present invention has been made in view of the above problems, and it is an object of the present invention to provide a method capable of displaying optimum video images without deteriorating the quality of the images although a video signal input device and a video display device are of different scanning types.

It is another object of the present invention to provide a method for displaying video images on a display device based on interlaced scanning where the video images are acquired by reducing captured video signals with different scaling ratios in horizontal and vertical directions and the captured video signals are made by one or more cameras based on the interlaced scanning.

In accordance with an aspect of the present invention, the above and other objects can be accomplished by the provision of a method for outputting video data in a video monitoring system outputting channel video signals of an interlaced scanning type captured by one or more cameras to a video display device of a progressive scanning type, comprising the steps of:

a) scaling each channel video data of the interlaced scanning type digitally converted with different horizontal and vertical scaling ratios;

b) storing the scaled video data for configuring one display screen in a memory; and

c) outputting and displaying the stored video data corresponding to the one display screen to the video display device of the progressive scanning type.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary video signal display screen explaining a conventional video-image outputting method;

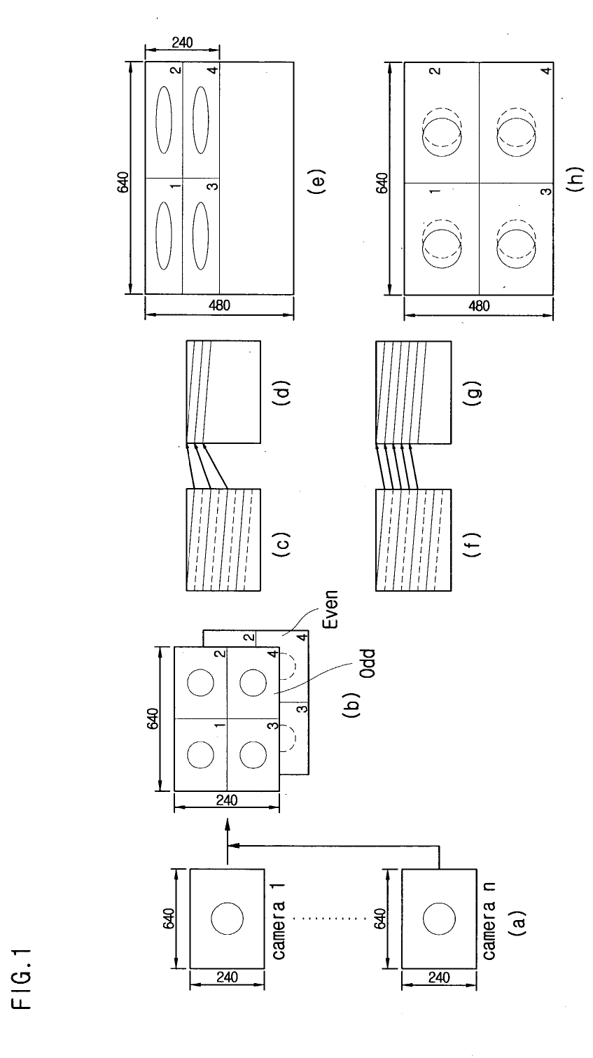

FIG. 2 is a view showing a configuration of a video monitoring system in accordance with an embodiment of the present invention; and

FIG. 3 is an exemplary video signal display screen explaining a video-image outputting method in accordance with an embodiment of the present invention.

### BEST MODE FOR CARRYING OUT THE INVENTION

Now, preferred embodiments of the present invention will be described in detail with reference to the annexed drawings. In the following description, a detailed description of known functions and configurations incorporated herein will be omitted when it may make the subject matter of the present invention rather unclear.

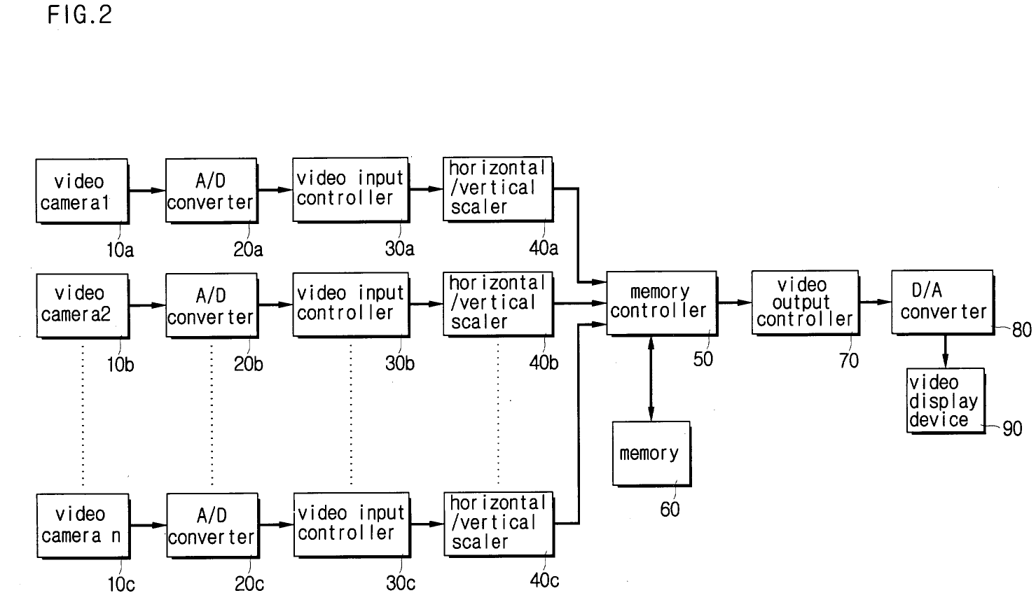

FIG. 2 is a view showing a configuration of a video monitoring system in accordance with an embodiment of the present invention.

Referring to FIG. 2, A/D (Analog/Digital) converters 20a-20c convert analog video signals inputted from installed video cameras 10a-10c to digital video data. The number of the A/D converters 20a-20c is the same as the number of the installed video cameras. Four, eight or more video cameras can be installed depending upon a monitored area.

Video input controllers 30a-30c extend the digital video data outputted from the A/D converters 20a-20c and separate and control horizontal and vertical synchronous signals to output them to a memory controller 50. The number of the video input controllers 30a-30c is the same as the number of the A/D converters 20a-20c.

Horizontal/vertical scalers 40a-40c reduce (or enlarge) the digital video data outputted from the video input controllers 30a-30c in a horizontal direction or/and a vertical direction so that the digital video data can be stored to be displayed on divided display screens. As known to those in the art, the horizontal/vertical scalers 40a 40c reduce the digital video data by performing interpolation between adjacent digital video data according to reduction ratios. The reduction (enlargement) ratios in the horizontal and vertical directions can be varied according to the number of divided display screens to be displayed on a video display device 90. Further, the reduction ratios in the horizontal and vertical directions can be varied according to a scanning type of the video display device 90. For this reason, it will be described below in detail. The number of the horizontal/vertical scalers 40a-40c is the same as the number of the video cameras 10a-10c.

A memory controller 50 records the reduced (or enlarged) video data outputted from the horizontal/vertical scalers 40a-40c at frame memory addresses designated channel by channel. The memory controller 50 reads and outputs the recorded video data so that it can be displayed as video images in real time. In response to the horizontal and vertical synchronous signals, the memory controller 50 configures one frame of a display screen containing “n” number of divided display screens where “n” is a positive integer.

The memory controller 50 controls access to the memory 60. After processing the video signals outputted from the video cameras 10a-10c, the memory 60 temporarily stores one frame of the video data. The video output controller 70 combines supplementary information (including time information, channel information, etc.) with the one frame of the video data outputted from the memory controller 50 to output it. The video data outputted from the video output controller 70 is converted into analog video signals by a D/A (Digital/Analog) converter 80. The video display device 90 can be a display device of the interlaced or progressive scanning type.

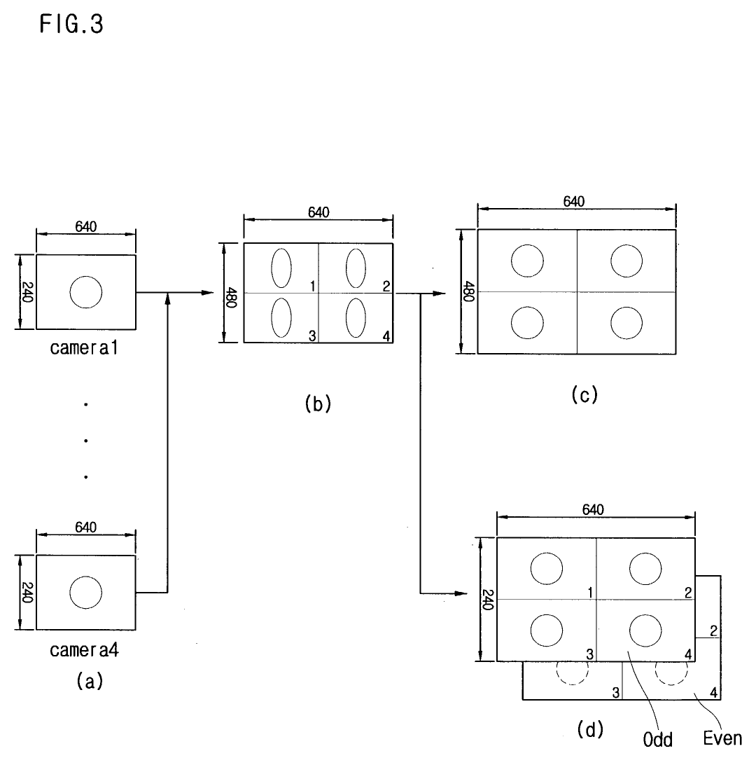

If the video cameras 10a-10c are of the interlaced scanning type and the video display device 90 is of the progressive scanning type in the video monitoring system described above, the video images can be outputted without the deterioration of the quality of images. This will be described below with reference to FIG. 3. The case that one frame for four divided display screens is configured and displayed on the four divided display screens will be described below.

FIG. 3 is an exemplary video signal display screen explaining a video-image outputting method in accordance with an embodiment of the present invention.

First, respective channel video signals captured by four video cameras 1-4 are converted into digital video data by the A/D converters 20a-20c. Horizontal/vertical synchronous signals are separated from the video input controllers 30a-30c. The video input controllers 30a-30c extend and control the digital video data for post-processing and output it to the horizontal/vertical scalers 40a-40c. The horizontal/vertical scalers 40a-40c are located at a rear stage of the video input controllers 20a-20c. If the horizontal/vertical scalers 40a-40c are designed to horizontally reduce the video data to half and not scale the video data in a vertical direction, “640×240” video data corresponding to each channel signal of an interlaced scanning type captured is reduced to “320×240” video data by them. The memory 60 stores the “320×240” video data under control of the memory controller 50.

Four divided display screens containing four video data only horizontally reduced to half are illustrated as shown in FIG. 3(b). For reference, FIG. 3(a) illustrates the “640×240” video data corresponding to each video signal of the interlaced scanning type captured. Because the four video data contained in a “640×480” area are made from the video signals received into a video signal input device of the interlaced scanning type as shown in FIG. 3(b), the video data corresponding to each divided display screen is distorted in the vertical direction. A spacing between horizontal lines, contained in a video display device of the interlaced scanning type, is twice as wide as that contained in another video display device of the progressive scanning type. Accordingly, if the video data corresponding to the video signals of the interlaced scanning type captured is horizontally reduced to half to configure the four divided display screens, then the four divided display screens shown in FIG. 3(b) are displayed. Further, where the video data corresponding to the video signals of the interlaced scanning type captured is outputted-to the video display device of the progressive scanning type, the reduced video data is naturally vertically reduced to half, because a spacing between horizontal lines contained in the video display device of the progressive scanning type is twice as narrow as that contained in an image of the interlaced scanning type. As a result, the video display device displays the four divided display screens normally as shown in FIG. 3(c).

In other words, moving image data, corresponding to four moving image signals of the interlaced scanning type captured, is horizontally reduced to half to configure the four divided display screens. Then, the reduced moving image data is outputted to the video display device of the progressive scanning type. Therefore, moving images can be properly displayed without deteriorating the quality of the moving images as shown in FIG. 3(c).

On the other hand, where the four moving image signals of the interlaced scanning type captured are outputted to another video display device of the progressive scanning type, video data corresponding to an odd line within each moving image data (in FIG. 3(b)) only horizontally reduced to half is outputted as video data corresponding to an odd field. Further, video data corresponding to an even line within each moving image data is outputted as video data corresponding to an even field. As shown in FIG. 3(d), two screens corresponding to the two fields are displayed on the video display device of the interlaced scanning type. As a result, a supervisor of the video monitoring system can view normal unblurred video images. Alternatively, the video data corresponding to the odd line can be outputted as the video data corresponding to the even field, and the video data corresponding to the even line can be outputted as the video data corresponding to the odd field.

It is clear from the above description that the memory controller controls the frame memory 60 depending upon the scanning type to be employed in the video display device. The memory controller reads out odd or even lines from the video data of the four divided display screens stored in the frame memory 60.

Although the present invention has been described in connection with one display screen configuring the four divided display screens, one display screen configuring nine or sixteen divided display screens can be equally applied in the present invention.

For example, it can be assumed that the nine divided display screens are configured and displayed on one display screen. At this time, the horizontal/vertical scalers 40a-40c perform 3:1 scaling with respect to channel video data, thereby reducing the number of pixels configuring one horizontal line contained in one channel video image to 214 pixels. Then, the horizontal/vertical scalers 40a-40c perform 3:2 scaling with respect to the channel video data, thereby reducing the number of pixels configuring one vertical line contained in one channel video image to 160 pixels. As a result, the nine divided display screens contained in a “640×480” area are configured and displayed within the one display screen. If a video display device of the progressive scanning type displays the nine divided display screens, the video images are displayed normally. Where the nine divided display screens are displayed on the video display device of the interlaced scanning type, video data corresponding to an odd line of the video data of the nine divided display screens can be properly displayed on an odd field as in the configuration of the four divided display screens described above. Further, video data corresponding to an even line of the video data of the nine divided display screens can be properly displayed on an even field as in the configuration of the four divided display screens described above.

Further, it is assumed that the sixteen divided display screens are configured and displayed on one display screen. At this time, the horizontal/vertical scalers 40a-40c perform 4:1 scaling in the horizontal direction with respect to sixteen video data corresponding to video signals of the interlaced scanning type captured. In other words, four pixels contained in a horizontal line of each of the sixteen video images are interpolated to make one pixel. Then, the horizontal/vertical scalers 40a-40c perform 2:1 scaling in the vertical direction with respect to the horizontally scaled sixteen video data. As a result, the sixteen divided display screens contained in a “640×480” area are displayed on the video display device of the interlaced or progressive scanning type as in the configuration of the four divided display screens.

In accordance with another embodiment of the present invention, video signals of the progressive scanning type captured can be outputted to a video display device of the interlaced scanning type. Where a video capture device for capturing the video signals of the progressive scanning type is a PC (Personal Computer) camera, the PC camera creates a captured “640×480” video signal. If the “640×480” video signal is outputted to a video display device capable of displaying a “640×240” video image of the interlaced scanning type, video data is not horizontally and vertically scaled (or is bypassed). Further, video data corresponding to an odd line of the video data stored in the frame memory 60 is outputted as video data corresponding to an odd field and another video data corresponding to an even line of the video data stored in the frame memory 60 is outputted as video data corresponding to an even field. At this time, an aspect ratio of an input signal can be equally retained with that of the video display device.

In accordance with the present invention, normal unblurred video images can be displayed although a video signal input device and a video display device are of different scanning types. Alternatively, an aspect ratio of an input signal can be equally retained with that of the video display device without scaling so that the normal video images can be displayed.

### INDUSTRIAL APPLICABILITY

As apparent from the above description, the present invention provides a method capable of displaying optimum video images without deteriorating the quality of the images by utilizing the fact that a spacing between horizontal lines contained in an image of an interlaced scanning type is twice as wide as that contained an image of a progressive scanning type, although a video signal input device and a video display device are of different scanning types.

Further, where a video signal of the interlaced scanning type captured is outputted and displayed on the video display device of the interlaced scanning type, a vivid video image can be displayed without deterioration of vertical resolution or quality of the image because the video image can be displayed equally with an aspect ratio of an original video image.

Although the present invention has been described in connection with specific preferred embodiments, those skilled in the art will appreciate that various modifications, additions, and substitutions to the specific elements are possible, without departing from the scope and spirit of the present invention as disclosed in the accompanying claims. Therefore, the present invention is not limited to the above-described embodiments, but the present invention is defined by the claims which follow, along with their full scope of equivalents.

1. A method for outputting video data in a video monitoring system outputting channel video signals of an interlaced scanning type captured by one or more cameras to a video display device of a progressive scanning type, comprising the steps of:
a) scaling each channel video data of the interlaced scanning type digitally converted with different horizontal and vertical scaling ratios;
b) storing the scaled video data for configuring one display screen in a memory; and
c) outputting and displaying the stored video data corresponding to the one display screen to the video display device of the progressive scanning type.

2. The method as set forth in claim 1, wherein each channel video data is horizontally scaled with a 2:1 scaling ratio and then is not vertically scaled or is bypassed so that each channel video data can be reduced.

3. The method as set forth in claim 1, wherein each channel video data is horizontally scaled with a 3:1 scaling ratio and then vertically scaled with a 3:2 scaling ratio so that each channel video data can be reduced.

4. The method as set forth in claim 1, wherein each channel video data is horizontally scaled with a 4:1 scaling ratio and then vertically scaled with a 2:1 scaling ratio so that each channel video data can be reduced.

5. A method for outputting video data in a video monitoring system outputting channel video signals of an interlaced scanning type captured by one or more cameras to a video display device of the interlaced scanning type, comprising the steps of:
a) scaling each channel video data of the interlaced scanning type digitally converted with different horizontal and vertical scaling ratios;
b) storing the scaled video data for configuring one display screen in a memory; and
c) outputting and displaying video data corresponding to an even line of the stored video data as video data corresponding to an even field, and outputting and displaying video data corresponding to an odd line of the stored video data as video data corresponding to an odd field.

6. The method as set forth in claim 5, wherein each channel video data is horizontally scaled with a 2:1 scaling ratio and then is not vertically scaled or is bypassed so that each channel video data can be reduced.

7. The method as set forth in claim 5, wherein each channel video data is horizontally scaled with a 3:1 scaling ratio and then vertically scaled with a 3:2 scaling ratio so that each channel video data can be reduced.

8. The method as set forth in claim 5, wherein each channel video data is horizontally scaled with a 4:1 scaling ratio and then vertically scaled with a 2:1 scaling ratio so that each channel video data can be reduced.

9. A method for outputting video data in a video monitoring system outputting channel video signals of an interlaced scanning type captured by one or more cameras to a video display device of the interlaced scanning type, comprising the steps of:
a) scaling each channel video data of the interlaced scanning type digitally converted with different horizontal and vertical scaling ratios;
b) storing the scaled video data for configuring one display screen in a memory; and
c) outputting and displaying video data corresponding to an even line of the stored video data as video data corresponding to an odd field, and outputting and displaying video data corresponding to an odd line of the stored video data as video data corresponding to an even field.

10. The method as set forth in claim 9, wherein each channel video data is horizontally scaled with a 2:1 scaling ratio and then is not vertically scaled or is bypassed so that each channel video data can be reduced.

11. A method for outputting video data in a video monitoring system outputting channel video signals of a progressive scanning type captured by a camera to a video display device of an interlaced scanning type, comprising the steps of:
a) storing each channel video data of the progressive scanning type digitally converted for configuring one display screen in a memory; and
b) outputting and displaying video data corresponding to an even line of the stored video data as video data corresponding to an odd field, and outputting and displaying video data corresponding to an odd line of the stored video data as video data corresponding to an even field.

12. A method for outputting video data in a video monitoring system outputting channel video signals of a progressive scanning type captured by a camera to a video display device of an interlaced scanning type, comprising the steps of:
a) storing each channel video data of the progressive scanning type digitally converted for configuring one display screen in a memory; and
b) outputting and displaying video data corresponding to an even line of the stored video data as video data corresponding to an even field, and outputting and displaying video data corresponding to an odd line of the stored video data as video data corresponding to an odd field.
